(19) United States
(12) Patent Application Publication
(10) Pub. No.: US 2010/0254033 A1
(43) Pub. Date: Oct. 7, 2010

(54) Lens module

(76) Inventor: Chih-Chou Wang, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,332

(22) Filed: Apr. 6, 2009

(51) Int. Cl. G02B 7/02

(52) U.S. Cl. 359/827

(57) ABSTRACT

A lens module includes a module body with a lens base and a lens unit disposed on the lens base and a lens module socket mated with the module body. The lens module socket has an insulting housing with a base portion. Lateral walls extend perpendicularly from edges of the base portion to form a receiving chamber for receiving the module body. A plurality of terminals is received in the insulting housing. A metal shell enclosing the insulting housing has lateral plates. Tops of the lateral plates define holding slices and fixing slices both of substantially inverted-U shape. A free end of the holding slice has a resisting portion holding a periphery of the lens base. A free end of the fixing slice has a stopping portion resilient to be positioned over the lens base after the lens base passes therefrom for preventing the lens base from moving outwards.

### BACKGROUND OF THE INVENTION

1. Field of the Invention

The invention relates to a lens module, and particularly to a lens module having an assembling structure adapted for fixing a module body and a lens module socket thereof.

2. The Related Art

Nowadays, the mass-production of lens modules that are widely applied in a variety of electronic devices with the function of taking photographs, such as mobile camera, personal digital assistants (PDAs) and the like, generally suffers from the disadvantage of a relatively high defect rate.

A conventional lens module includes a lens module socket which is made of insulating material and has side walls connected end to end to form a receiving chamber, and a module body received in the receiving chamber of the lens module socket. The module body has a lens base of rectangular block shape and a lens unit disposed on the lens base. Nevertheless, when the module body is received into the receiving chamber of the lens module socket, it is easy to produce a movement between the module body and the lens module socket, resulting in skew and unclear shoot images. Therefore, there is a need to provide an improved lens module that can overcome or at least reduce the disadvantage set forth above.

### SUMMARY OF THE INVENTION

An object of the present invention is to provide a lens module with an assembling structure adapted for fixing a module body and a lens module socket thereof.

The lens module includes a module body having a lens base of rectangular block shape and a lens unit of cylindrical shape disposed on the lens base, a lens module socket mated with the module body. The lens module socket has an insulting housing with a base portion of rectangular shape. Lateral walls extend perpendicularly from edges of the base portion to form a receiving chamber for receiving the module body. A plurality of terminals is received in the insulting housing for electrically connecting with the module body. A metal shell engaged with the insulting housing has lateral plates enclosing the lateral walls of the insulating housing. Holding slices and fixing slices both of substantially inverted-U shape bend inwards from tops of the corresponding lateral plates. Each of the holding slices has a free end extending to form a resisting portion extending into the receiving chamber for holding a periphery of the lens base. Each of the fixing slices has a free end extending to form a stopping portion with higher position than the resisting portion extending into the receiving chamber. The stopping portions are resilient to be positioned over the lens base after the lens base passes therefrom for preventing the lens base from moving outwards.

As described above, the holding slices with the resisting portions extending into the receiving chamber for holding the periphery of the lens base are capable of preventing the lens module from circumvolving in the insulting housing, as well as the fixing slice has the stopping portion resilient to be positioned over the lens base after the lens base passes therefrom for preventing the lens base from moving outwards, which can keep the lens module at the initial location, and obtain the clear images without deflection.

### BRIEF DESCRIPTION OF THE DRAWINGS

The present invention will be apparent to those skilled in the art by reading the following description of an embodiment thereof, with reference to the attached drawings, in which:

FIG. 1 is an assembled, perspective view of a lens module according to the present invention;

FIG. 2 is a perspective view of a module body of the lens module shown in FIG. 1;

FIG. 3 is a perspective view of a lens module socket of the lens module shown in FIG. 1;

FIG. 4 is an explode, perspective view of the lens module socket shown in FIG. 3;

FIG. 5 is a perspective view of an insulting housing of the lens module socket shown in FIG. 4 viewed from a bottom angle; and

FIG. 6 is a perspective view of a metal shell of the lens module socket shown in FIG. 3.

### DETAILED DESCRIPTION OF THE EMBODIMENT

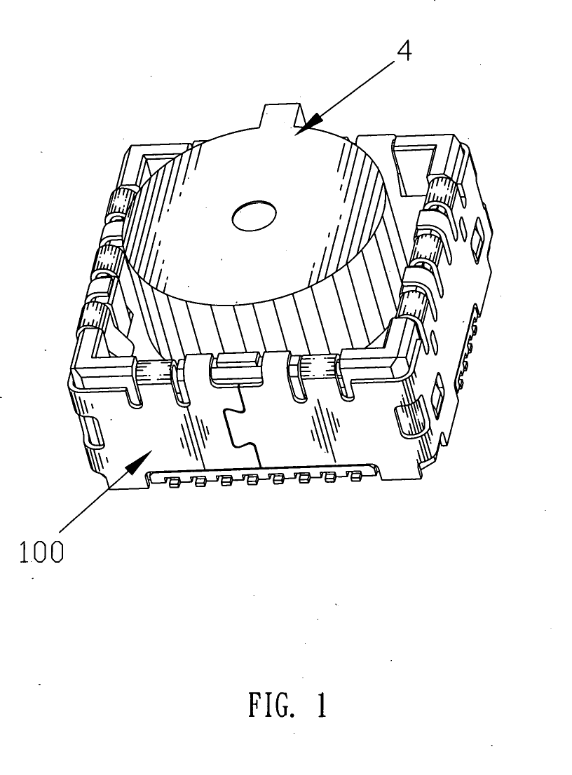

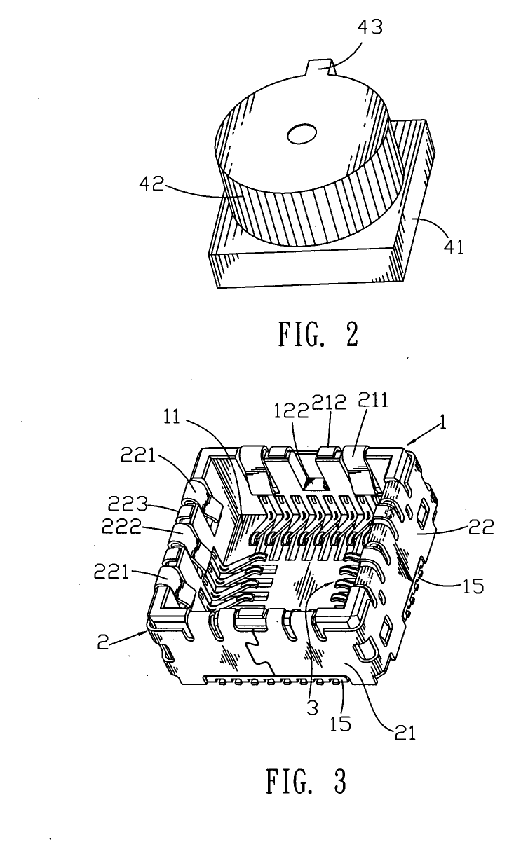

Please refer to FIGS. 1-3, a lens module of an embodiment in accordance with the present invention is shown. The lens module includes a lens module socket 100 and a module body 4. The lens module socket 100 includes an insulating housing 1, a metal shell 2 enclosing the insulting housing 1 and a plurality of terminals 3 received in the insulting housing 1. The module body 4 includes a lens base 41 of rectangular block shape, and a lens unit 42 of cylindrical shape disposed on the lens base 41. A fool-proof projection 43 is protruded outwards from a side of the lens unit 42.

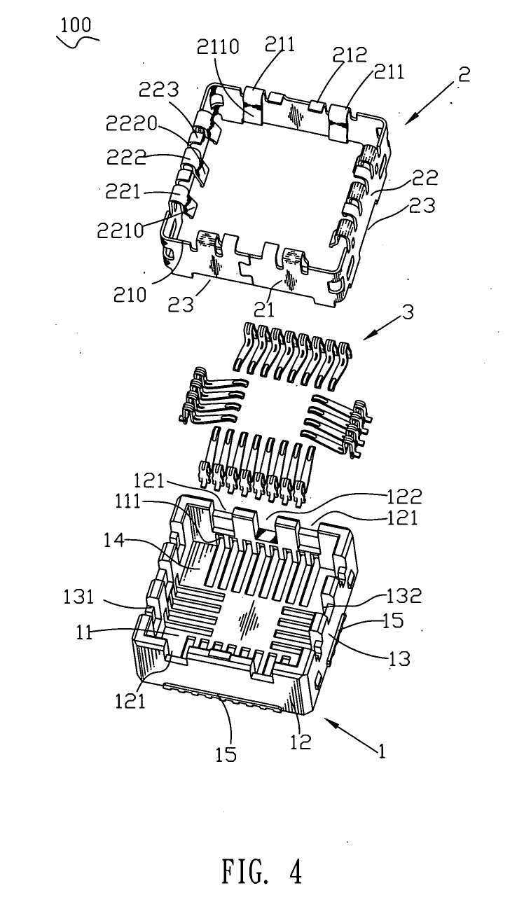

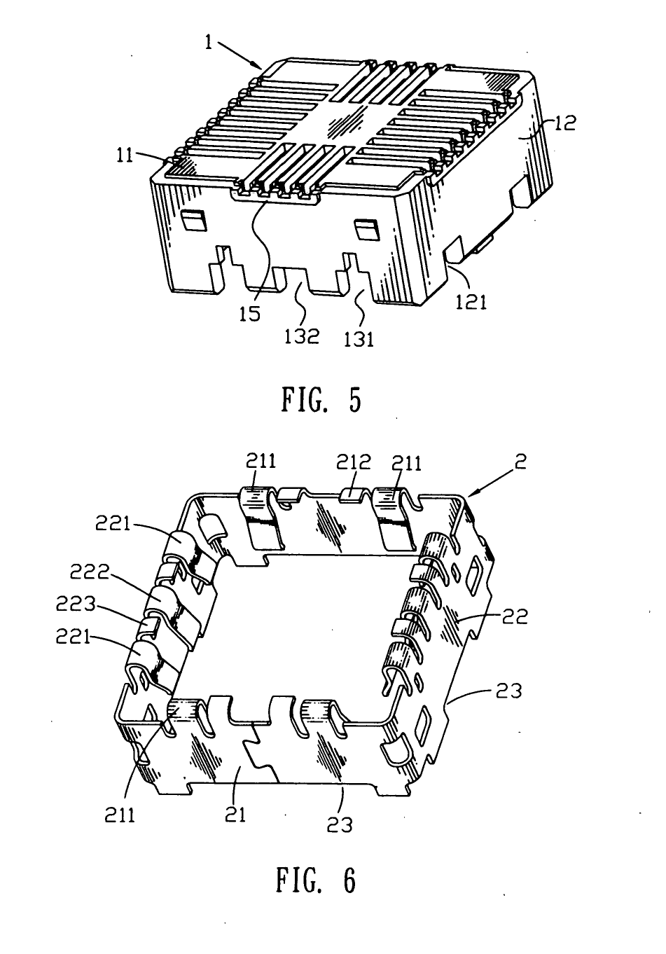

With reference to FIGS. 4-5, the insulating housing 1 has a base portion 11 of rectangular shape. Edges of the base portion 11 extend perpendicularly to the base portion 11 to form two facing first lateral walls 12 and two facing second lateral walls 13 connected with the first lateral walls 12 to form a receiving chamber 14 for receiving the module body 4. Each of the first lateral walls 12 has two holding recesses 121 of substantially inverted-L shape at an upper portion thereof to penetrate an inner surface, a top surface and an outer surface thereof. The holding recesses 121 of each of the first lateral walls 12 are arranged to be spaced away from and substantially symmetrical about a middle of the first lateral wall 12. The corresponding holding recesses 121 of the two first lateral walls 12 are face to face. The inner surface of one of the first lateral walls 12 defines a fool-proof groove 122 at the middle thereof, disposed between the holding recesses 121, corresponding to the fool-proof projection 43 of the module body 4 for insuring accurate assembly. Each of the second lateral walls 13 defines two fixing recesses 131 and a holding recess 132 between the fixing recesses 131 at an upper portion thereof, specifically, the holding recess 132 is arranged at a middle thereof, the two fixing recesses 131 are arranged to be spaced away from and substantially symmetrical about the holding recess 132. The fixing recesses 131 and the holding recesses 132 are both substantially inverted-L shape to penetrate an inner surface, a top surface and an outer surface of the second lateral walls 13. The corresponding fixing recesses 131 and the holding recesses 132 of the two second lateral walls 13 are face to face. A protrusion 15 of strip shape is protruded outwards from a bottom of the outer surface of each of the first lateral walls 12 and second lateral walls 13, extending parallel to the base portion 11. The base portion 11 of the insulating housing 1 further has a plurality of terminal grooves 111 for receiving the terminals 3. The terminal grooves 111 spread to pass through the lateral walls 12, 13 and the protrusions 15 for allowing the terminals 3 to partly extend outside the lateral walls 12, 13, to be soldered on a printed circuit board (not shown).

Referring to FIG. 4, the metal shell 2 has two facing first lateral plates 21 and two facing second lateral plates 22 respectively wrapping the first lateral walls 12 and the second lateral walls 13 of the insulting housing 1. The first lateral plate 21 defines a top edge 210, and has two holding slices 211 arranged to be spaced away from and substantially symmetrical about a middle thereof and received in the holding recesses 121, two buckling portions 212 disposed between the holding slices 211. The corresponding holding slices 211 of the two first lateral plates 21 are face to face, bent inwards and extended towards the base portion 11 from the top edge 210 to show a substantially inverted-U shape. A free end of the holding slices 211 extends obliquely, apart from the first lateral plate 21, to form a resisting portion 2110 for resting against a periphery of the lens base 41. The buckling portions 212 are bent inwards from the top edge 210 to show an inverted-L shape, clasping the tops of the insulating housing 1 for fixing the insulating housing 1 and the metal shell 2. The second lateral plate 22 has a holding slice 222 same as the holding slice 211 arranged substantially at a middle thereof and received in the holding recess 132, two fixing slices 221 arranged to be spaced away from and substantially symmetrical about the corresponding holding slice 222. The corresponding fixing slices 221 of the two second lateral plates 22 are face to face, received in the fixing recesses 131. The fixing slice 221, which is substantially same as the holding slice 211, 222, has a stopping portion 2210 with higher position than the resisting portion 2110 extending into the receiving chamber 14, resilient to be positioned over the lens base 41 after the lens base 41 passes therefrom. The holding slice 222 has a resisting portion 2220 same as the resisting portion 2110. The second lateral plate 22 further has two bucking portions 223, same as the buckling portion 212 of the first lateral plate 21, arranged alternately between the fixing slices 221 and the holding slice 222 to clasp the top of the second lateral wall 13 for fixing the metal shell 2 to the insulating housing 1. The first lateral plate 21 and the second lateral plate 22 further have an indention 23 at a bottom thereof, respectively, corresponding to the protrusion 15 for preventing the metal shell 2 from connecting with the terminals 3.

As describe above, the holding slices 211, 222 and -the fixing slices 221 are received in the holding recesses 121, 132 and the fixing recesses 131. The resisting portions 2110, 2220 and the stopping portions 2210 exceed the corresponding holding recesses 121, 132 and the corresponding fixing recesses 131 to enter into the receiving chamber 14. When the module body 4 is disposed in the receiving chamber 14 of the insulting housing 1, the resisting portions 2110, 2220 hold the periphery of the lens base 41 for preventing the module body 4 from circumvolving in the insulting housing 1, and the stopping portions 2210 are resilient to be positioned over the lens base 41 for preventing the module body 4 from moving out of the insulating housing 1, which can insure the module body 4 at the initial location with respect to the lens module socket 100 so as to obtain the clear images without deflection.

Furthermore, the present invention is not limited to the embodiment described above; various additions, alterations and the like may be made within the scope of the present invention by a person skilled in the art. For example, respective embodiments may be appropriately combined.

What is claimed is:

1. A lens module, comprising:
a module body having a lens base of rectangular block shape and a lens unit of cylindrical shape disposed on the lens base; and
a lens module socket, comprising
an insulting housing having a base portion of substantially rectangular shape and lateral walls extended perpendicularly from edges of the base portion to form a receiving chamber for receiving the module body;
a plurality of terminals received in the insulting housing for electrically connecting with the module body; and
a metal shell engaged with the insulting housing having lateral plates enclosing the lateral walls of the insulating housing, holding slices and fixing slices both of substantially inverted-U shape bent inwards from tops of the corresponding lateral plates, each of the holding slices having a free end extending to form a resisting portion extending into the receiving chamber for holding a periphery of the lens base, each of the fixing slices having a free end extending to form a stopping portion with higher position than the resisting portions extending into the receiving chamber, the stopping portions being resilient to be positioned over the lens base after the lens base passes therefrom for preventing the lens base from moving outwards.

2. The lens module as claimed in claim 1, wherein the corresponding lateral walls define holding recesses of substantially inverted-L shape at an upper portion thereof to penetrate an inner surface, a top surface and an outer surface thereof for disposing the corresponding holding slices therein.

3. The lens module as claimed in claim 1, wherein the corresponding lateral walls define fixing recesses of substantially inverted-L shape at an upper portion thereof to penetrate an inner surface, a top surface and an outer surface thereof for disposing the corresponding fixing slices therein.

4. The lens module as claimed in claim 1, wherein the lateral plates of the metal shell includes two facing first lateral plates and two facing second lateral plates, each of the two first lateral plates has two of the holding slices arranged to be spaced away from and substantially symmetrical about a middle thereof, the corresponding holding slices of the two first lateral plates are face to face, each of the two second lateral plates has one of the holding slice arranged substantially at a middle thereof.

5. The lens module as claimed in claim 4, wherein the fixing slices are disposed only on the two second lateral plates, each of the second lateral plates has two of the fixing slices arranged to be spaced away from and substantially symmetrical about the corresponding holding slice, the corresponding fixing slices of the two second lateral plates are face to face.

6. The lens module as claimed in claim 4, wherein an inner surface of one of the lateral walls further defines a fool-proof groove at a middle thereof for receiving a fool-proof projection protruded from a side of the lens unit for accurate assembly.

7. The lens module as claimed in claim 1, wherein the tops of the lateral plates further have portions bent inwards to form a plurality of buckling portions of inverted-L shape clasping tops of the lateral walls for fixing the metal shell to the insulating housing.

8. The lens module as claimed in claim 1, wherein a bottom of the lateral wall protrudes outwards to form a protrusion of strip shape where a plurality of terminal grooves formed on the base portion pass through, the lateral plate has an indention at a bottom thereof corresponding to the protrusion for preventing the metal shell from connecting with the terminals.
